(19) United States
(12) Patent Application Publication
(10) Pub. No.: US 2026/0303488 A1
(43) Pub. Date: Oct. 1, 2026

(54) SCHEDULING TELEMETRY DATA COLLECTION FOR AN INFORMATION HANDLING SYSTEM

(71) Applicant: Dell Products L.P., Round Rock, TX (US)

(72) Inventors: Alan Helmy Abdelhalim, Pflugerville, TX (US); Jacob Vincent Mink, Cedar Park, TX (US); Yves Christian Dolce, Redmond, WA (US)

(21) Appl. No.: 19/089,210

(22) Filed: Mar. 25, 2025

(51) Int. Cl. H04L 43/022

(52) U.S. Cl. CPC H04L 43/022

(57) ABSTRACT

Scheduling telemetry data collection, including receiving a first request from a first subscriber computing module for a first telemetry datatype, the first request including a first sampling frequency of the first telemetry datatype; comparing the first telemetry datatype to a table of a plurality of telemetry datatypes, the table indicating, for each telemetry datatype of the plurality of telemetry datatypes, a sampling frequency of the telemetry datatype; identifying a particular sampling frequency for the first telemetry datatype as indicated by the table; determining that the first sampling frequency is greater than the particular sampling frequency, and in response: updating the table to adjust the sampling frequency for the first telemetry datatype from the particular sampling frequency to the first sampling frequency; identifying subscriber computing modules of the first telemetry datatype; providing, to the first subscriber computing module, the first telemetry datatype based on the first sampling frequency.

### BACKGROUND

### Field of the Disclosure

The disclosure relates generally to an information handling system, and in particular, scheduling telemetry data collection for an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Telemetry data collection involves the gathering and transmission of data from various sensors and devices to a central system for monitoring and analysis. This data can include information on system performance, environmental conditions, and user interactions. Telemetry is widely used in fields such as aerospace, healthcare, and IT to ensure systems are functioning correctly and to predict potential issues. By analyzing telemetry data, organizations can make informed decisions, improve efficiency, and enhance overall system reliability.

### SUMMARY

Innovative aspects of the subject matter described in this specification may be embodied in a method of scheduling telemetry data collection for an information handling system, including receiving a first request from a first subscriber computing module for a first telemetry datatype of the information handling system, the first request including a first sampling frequency of the first telemetry datatype; comparing the first telemetry datatype to a table of a plurality of telemetry datatypes stored at a data store, the table indicating, for each telemetry datatype of the plurality of telemetry datatypes, a sampling frequency of the telemetry datatype; determining, based on the comparing, that the table includes the first telemetry datatype; identifying, based on the determining, a particular sampling frequency for the first telemetry datatype as indicated by the table; determining whether the first sampling frequency is greater than the particular sampling frequency; determining that the first sampling frequency is greater than the particular sampling frequency, and in response: updating the table to adjust the sampling frequency for the first telemetry datatype from the particular sampling frequency to the first sampling frequency; after updating the table, identifying one or more subscriber computing modules of the first telemetry datatype; and providing, to the first subscriber computing module, the first telemetry datatype based on the first sampling frequency.

Other embodiments of these aspects include corresponding systems, apparatus, and computer programs, configured to perform the actions of the methods, encoded on computer storage devices.

These and other embodiments may each optionally include one or more of the following features. For instance, updating the table further includes adding the first subscriber computing module as a subscriber of the first telemetry datatype. The request includes a time duration, determining, for the first subscriber computing module, whether the time duration has lapsed; and determining, for the first subscriber computing module, that the time duration has not lapsed, and in response, providing, to the first subscriber computing module, the first telemetry datatype based on the first sampling frequency. The request includes in a time duration, determining, for the first subscriber computing module, whether the time duration has lapsed; and determining, for the first subscriber computing module, that the time duration has lapsed, and in response, ceasing to provide, to the first subscriber computing module, the first telemetry datatype. Determining that the first sampling frequency is less than the particular sampling frequency, and in response: maintaining the table to keep the sampling frequency for the first telemetry datatype as the particular sampling frequency; and providing, to the first subscriber computing module, the first telemetry datatype based on the particular sampling frequency. Maintaining the table further includes adding the first subscriber computing module as a subscriber of the first telemetry datatype. Determining, based on the comparing, that the table does not include the first telemetry datatype, and in response: updating the table to include the first telemetry datatype and the first sampling frequency for the first telemetry datatype. Receiving a second request from a second subscriber computing module for the first f telemetry datatype of the information handling system, the second request including a second sampling frequency of the first telemetry datatype; determining whether the second sampling frequency is greater than the first sampling frequency; determining that the second sampling frequency is greater than the first sampling frequency, and in response: updating the table to adjust the sampling frequency for the first telemetry datatype from the first sampling frequency to the second sampling frequency; after updating the table, providing, to the first subscriber computing module, the first telemetry datatype based on the second sampling frequency; and providing, to the second subscriber computing module, the first telemetry datatype based on the second sampling frequency.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for scheduling telemetry data collection.

FIG. 3 illustrates a method for scheduling telemetry data collection.

### DESCRIPTION OF PARTICULAR EMBODIMENT(S)

This disclosure discusses methods and systems for scheduling telemetry data collection of an information handling system. In short, the invention enhances telemetry collection by consolidating such into a single, centralized process. This process efficiently handles requests from multiple applications and schedules data collection. By recognizing that different applications may require the telemetry data at various sampling frequencies, the invention categorizes, tracks, and applies the most stringent schedule for each datatype of the telemetry data to meet all application needs. In short, the invention centralizes data collection, optimizing individual queries for better performance, and dynamically adjusting the collection strategy to accommodate all requests simultaneously. This approach allows applications to sample data at their desired rate or better, with minimal system impact. Additionally, client requests are designed with limited or expiring durations to prevent long-term impact.

Specifically, this disclosure discusses a system and a method for scheduling telemetry data collection for an information handling system, including receiving a first request from a first subscriber computing module for a first datatype telemetry datatype of the information handling system, the first request including a first sampling frequency of the first telemetry datatype; comparing the first telemetry datatype to a table of a plurality of telemetry datatypes stored at a data store, the table indicating, for each telemetry datatype of the plurality of telemetry datatypes, a sampling frequency of the telemetry datatype; determining, based on the comparing, that the table includes the first telemetry datatype; identifying, based on the determining, a particular sampling frequency for the first telemetry datatype as indicated by the table; determining whether the first sampling frequency is greater than the particular sampling frequency; determining that the first sampling frequency is greater than the particular sampling frequency, and in response: updating the table to adjust the sampling frequency for the first telemetry datatype from the particular sampling frequency to the first sampling frequency; after updating the table, identifying one or more subscriber computing modules of the first telemetry datatype; and providing, to the first subscriber computing module, the first telemetry datatype based on the first sampling frequency.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

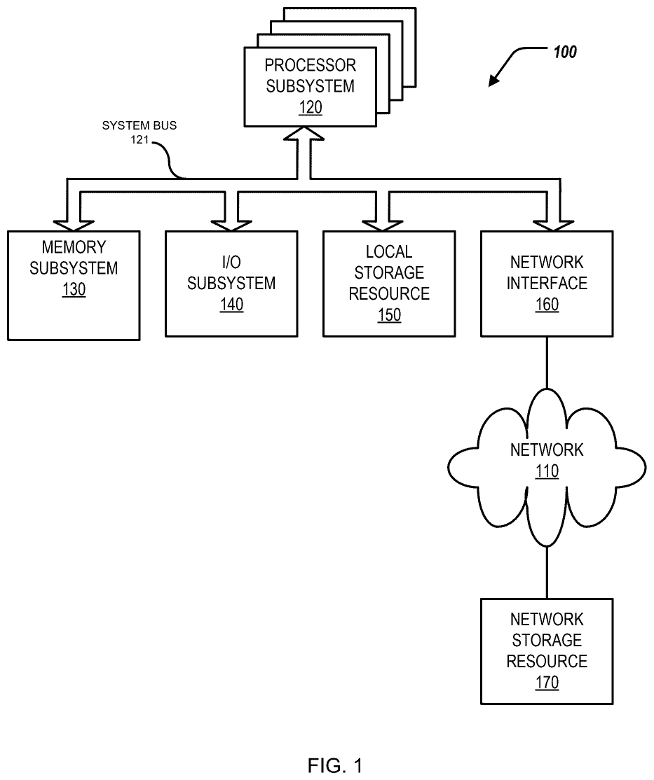

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

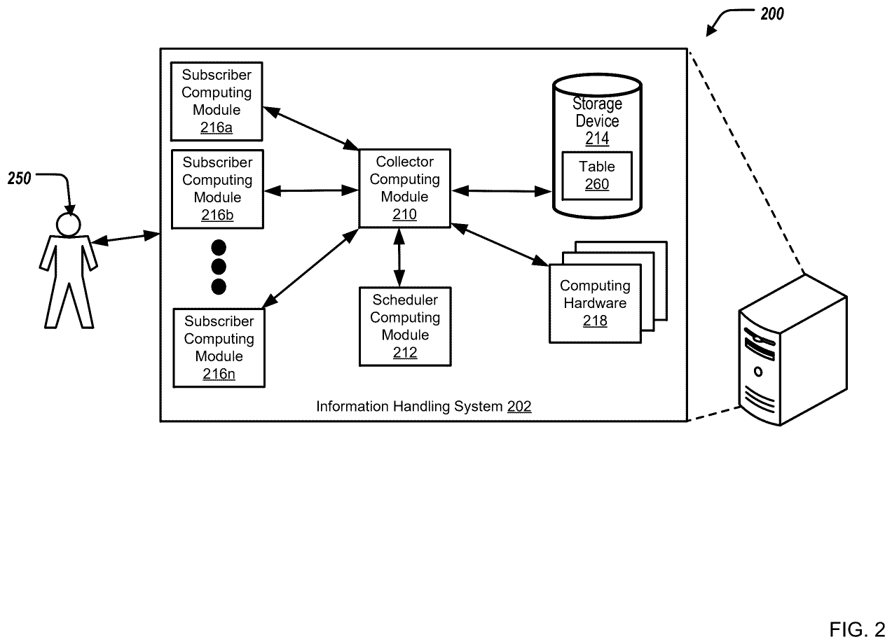

Turning to FIG. 2, FIG. 2 illustrates an environment 200 including an information handling system 202. The information handling system 202 can include a collector computing module 210; a scheduler computing module 212; a storage device 214; subscriber computing modules 216a, 216b, . . . and 216n (collectively referred to as subscriber computing modules 216); and computing hardware 218. In some examples, the information handling system 202 is similar to, or includes, the information handling system 100 of FIG. 1.

The computing hardware 218 can include memory, storage devices, video cards, audio cards, processors, and the like.

The collector computing module 210 can be in communication with the scheduler computing module 212, the storage device 214, the subscriber computing modules 216, and the computing hardware 218. The scheduler computing module 212 can be in communication with the collector computing module 210. The subscriber computing modules 216 can be in communication with the collector computing module 210. The computing hardware 218 can be in communication with the collector computing module 210.

In short, the invention enhances telemetry collection by consolidating such into a single, centralized process. This process efficiently handles requests from multiple applications and schedules data collection. By recognizing that different applications may require the telemetry data at various sampling frequencies, the invention categorizes, tracks, and applies the most stringent schedule for each datatype of the telemetry data to meet all application needs. In short, the invention centralizes data collection, optimizing individual queries for better performance, and dynamically adjusting the collection strategy to accommodate all requests simultaneously. This approach allows applications to sample data at their desired rate or better, with minimal system impact. Additionally, client requests are designed with limited or expiring durations to prevent long-term impact.

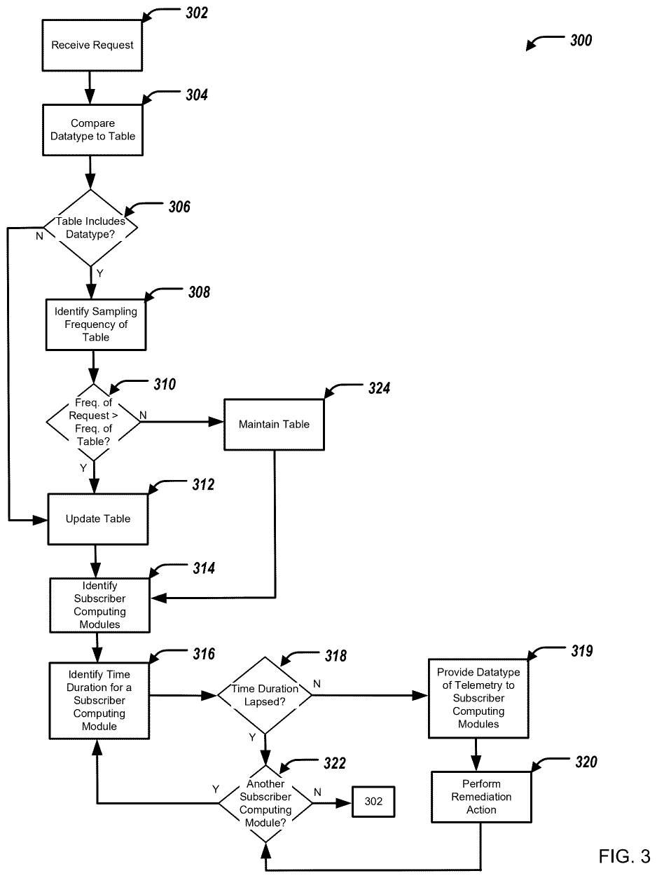

FIG. 3 illustrates a flowchart depicting selected elements of an embodiment of a method 300 for scheduling telemetry data collection. The method 300 may be performed by the information handling system 100, the information handling system 202, the collector computing module 210 and/or the scheduler computing module 212, and with reference to FIGS. 1-2. It is noted that certain operations described in method 300 may be optional or may be rearranged in different embodiments.

The collector computing module 210 receives a request from the subscriber computing module 216a for a first telemetry datatype of the information handling system 202, at 302. The telemetry data can be associated with the computing hardware 218. The telemetry data can include such data as processor (CPU) dynamics, battery static data, temperatures of the computing hardware 218, and the like. The telemetry data can include differing datatypes. The datatypes can be a collection of units of telemetry data. The telemetry datatypes can be a logical collection of related data points of the telemetry data. The telemetry datatypes can be categorized as on-demand, periodic, or event-based.

The request from the subscriber computing module 216a can include a first sampling frequency of the first telemetry datatype. The sampling frequency of the first telemetry datatype can indicate how often the first telemetry datatype is collected/sampled by the scheduler computing module 212. For example, the sampling frequency can be 1 minute, 1 hour, or 1 day.

The request from the subscriber computing module 216a can further include a time duration of subscription to the first telemetry datatype. The time duration can indicate how long the subscriber computing module 216a receives (subscribes to) the first telemetry datatype at the sampling frequency. For example, the time duration can be 1 day, 1 week, or 1 year.

The collector computing module 210 can compare the first telemetry datatype to a table 260, at 304. The table 260 can include data indicating a plurality of telemetry datatype, and for each telemetry datatype of the plurality of telemetry datatypes, a sampling frequency of the telemetry datatype. For example, for datatype A, the table 260 can indicate a sampling frequency Z; and for datatype B, the table 260 can indicate a sampling frequency Y; and so forth.

The collector computing module 210 can determine, based on the comparing, whether the table 260 includes the first telemetry datatype, at 306. In some examples, the collector computing module 210 determines that the table 260 includes the first telemetry datatype; that is, that the table 260 includes data indicating the first telemetry datatype. In response to determining that the collector computing module 210 determines that the table 260 includes the first telemetry datatype, the collector computing module 210 identifies a particular sampling frequency for the first telemetry datatype as indicated by the table 260, at 308. That is, the collector computing module 210 identifies the particular sampling frequency that is indicated by the table 260 as being associated with the first telemetry datatype, and provides such to the schedule computing module 212.

The scheduler computing module 212 determines whether the first sampling frequency is greater than the particular sampling frequency, at 310. That is, the scheduler computing module 212 determines whether the first sampling frequency of the request from the subscriber computing module 216a is greater than the particular sampling frequency that is indicated by the table 260. Specifically, the scheduler computing module 212 determines whether the first sampling frequency is more frequent than the particular sampling frequency.

In some examples, the scheduler computing module 212 determines that the first sampling frequency is greater than the particular sampling frequency (at 310). That is, the scheduler computing module 212 determines that the first sampling frequency of the request from the subscriber computing module 216a is greater than the particular sampling frequency that is indicated by the table 260, and provide such data to the collector computing module 210. For example, the first sampling frequency can be every 5 minutes (of the request) and the particular sampling frequency (of the table 260) can be every 12 hours. In other words, the first sampling frequency is the shortest sampling/collection frequency/interval.

In response to determining that the first sampling frequency is greater than the particular sampling frequency, the collector computing module 210 updates the table 260, at 312. Specifically, the collector computing module 210 updates the table 260 to adjust the sampling frequency for the first telemetry datatype from the particular sampling frequency to the first sampling frequency (of the request). That is, the collector computing module 210 updates the table 260 to replace the particular sampling frequency with the first sampling frequency for the first telemetry datatype as the first sampling frequency (of the request) is a shorter sampling/collection frequency/interval (a “stricter” sampling frequency). For example, the collector computing module 210 updates the table 260 to adjust the sampling frequency for the first telemetry datatype from the particular sampling frequency of every 12 hours to the first sampling frequency of every 5 minutes.

In some examples, the collector computing module 210 further updates the table 260 to add the subscriber computing module 216a as a subscriber of the first datatype of the telemetry data. That is, the table 260 can indicate for the first telemetry datatype, the sampling frequency for the first telemetry datatype and the computing modules that subscribe to updates to the first telemetry datatype. Thus, when sampling of the first telemetry datatype occurs, the collector computing module 210 can facilitate providing the first telemetry datatype to the subscriber computing module 216a based on the sampling frequency associated with the first telemetry datatype as indicated by the table 260 (e.g., the first sampling frequency).

The collector computing module 210, after updating the table 260, identifies subscriber computing modules 216 that subscribe to the first telemetry datatype, at 314. The table 260 can indicate, for each telemetry datatype, subscribers of the telemetry datatype. For example, for the first telemetry datatype, the table 260 can indicate that the subscriber computing module 216a is a subscriber of the first telemetry datatype at the indicated sampling frequency (the first sampling frequency of every 5 minutes).

The collector computing module 210 identifies, for the subscriber computing module 216a, the time duration, at 316. That is, the collector computing module 210 accesses the table 260 to identify the time duration that is associated with the subscriber computing module 216a for the first telemetry datatype.

The collector computing module 210 determines, for the subscriber computing module 216a, whether the time duration has lapsed, at 318. In some examples, the collector computing module 210 determines, for the subscriber computing module 216a, that the time duration has not lapsed (at 318), and in response, provides, to the subscriber computing module 216a, the first telemetry datatype at the first sampling frequency as indicated by the table 260, at 319.

Specifically, the collector computing module 210 can obtain (poll) the first telemetry datatype from the appropriate computing hardware 218 at the first sampling frequency. That is, at the first sampling frequency as indicated by the table 260, the collector computing module 210 obtains the first telemetry datatype from the appropriate computing hardware 218. The collector computing module 210 can then provide the first telemetry datatype at the first sampling frequency to the subscriber computing module 216a (e.g., through the collector computing module 210).

The subscriber computing module 216a can perform, based on the first sampling frequency of the first telemetry datatype, a remediation action at the computing hardware 218, at 320. That is, the subscriber computing module 216a can be in communication with the computing hardware 218. The subscriber computing module 216 can perform remediation action at the computing hardware 218 in response to receiving the first telemetry datatype.

In some examples, the subscriber computing module 216a, in response to receiving the first telemetry datatype, can perform the remediation action of uninstalling a driver associated with an appropriate computing hardware 218 without input/interaction by a user 250. That is, the subscriber computing module 216a can uninstall, or facilitate uninstallation of, the driver at an appropriate computing hardware 218 automatically in response to receiving the first telemetry datatype.

In some examples, the subscriber computing module 216a, in response to receiving the first telemetry datatype, can perform the remediation action of updating a driver associated with an appropriate computing hardware 218 without input/interaction by a user 250. That is, the subscriber computing module 216a can update, or facilitate updating of, the driver at an appropriate computing hardware 218 automatically in response to receiving the first telemetry datatype.

In some examples, the subscriber computing module 216a, in response to receiving the first telemetry datatype, can perform the remediation action of disabling a driver associated with an appropriate computing hardware 218 without input/interaction by a user 250. That is, the subscriber computing module 216a can disable, or facilitate disabling of, the driver at an appropriate computing hardware 218 automatically in response to receiving the first telemetry datatype.

In some examples, the subscriber computing module 216a, in response to receiving the first telemetry datatype, can perform the remediation action of installing a driver associated with an appropriate computing hardware 218 without input/interaction by a user 250. That is, the subscriber computing module 216a can install, or facilitate installing of, the driver at an appropriate computing hardware 218 automatically in response to receiving the first telemetry datatype.

In some examples, the subscriber computing module 216a, in response to receiving the first telemetry datatype, can perform the remediation action of updating firmware associated with an appropriate computing hardware 218 without input/interaction by a user 250. That is, the subscriber computing module 216a can update, or facilitate updating of, the firmware at an appropriate computing hardware 218 automatically in response to receiving the first telemetry datatype.

In some examples, the subscriber computing module 216a, in response to receiving the first telemetry datatype, can perform the remediation action of updating a configuration associated with an appropriate computing hardware 218 without input/interaction by a user 250. That is, the subscriber computing module 216a can update, or facilitate updating of, the configuration at an appropriate computing hardware 218 automatically in response to receiving the first telemetry datatype.

In some examples, the subscriber computing module 216a, in response to receiving the first telemetry datatype, can perform the remediation action of executing diagnostic operations at the appropriate computing hardware 218, such as processor diagnostics. In some examples, the subscriber computing module 216a, in response to receiving the first telemetry data, can perform the corrective action of closing applications executing at the information handling system 202, including switching application modes.

In some examples, the subscriber computing module 216a, in response to receiving the first telemetry datatype, can perform the remediation action of preloading computer-implemented applications or files at the information handling system at the appropriate computing hardware 218 without input/interaction by the user 250. In some examples, the computer-implemented applications or files that are preloaded by the appropriate computing hardware 218 can be based on the first telemetry datatype indicating which applications and/or files are frequently accessed.

In some examples, the subscriber computing module 216a, in response to receiving the first telemetry datatype, can perform the remediation action of adjusting the collection frequency of the first telemetry datatype without input/interaction by the user 250. In some examples, the subscriber computing module 216a can adjusting the collection frequency of the first telemetry datatype based on the first telemetry datatype indicating anomalies in the first telemetry datatype.

In some examples, the subscriber computing module 216a, in response to receiving the first telemetry datatype, can perform the remediation action of throttling of computer-implemented applications executed at the information handling system 202, without input/interaction by the user 250. In some examples, the processor or other computing hardware of the information handling system 202 can be throttled based on the first telemetry datatype.

The subscriber computing module 216 performs the remediation action independent of user action by the user 250 of the information handling system. That is, the subscriber computing module 216 performs the remediation action at the information handling system 202 (and specifically, at the computing hardware 218) automatically in response to receiving the first telemetry datatype and without user interaction/input. The subscriber computing module 216 can perform the remediation action (or remediation actions) to provide operability of the computing features of the computing hardware 218 by improving performance capabilities of the information handling system 202 (such as the computing hardware 218). That is, performing the remediation action(s) to the computing hardware 218 by the subscriber computing module 216 improves the performance capabilities of the information handling system 202 (the computing hardware 218) such that the functionality and the operability of the computing features of the computing hardware 218 is improved. In some examples, the subscriber computing module 216 can perform the remediation action (or remediation actions) to improve the performance capabilities of the information handling system 202 without user action/input by the user 250 (independent of user action/input by the user 250).

After performing the remediation action (at 320), the collector computing module 210 determines whether there is another subscriber computing module 216 that subscribes to the first telemetry datatype as indicated by the table 260, at 322. That is, the collector computing module 210 determines whether the table 260 indicates another subscriber of the first telemetry datatype. In some examples, the collector computing module 210 determines that there is another subscriber computing module 216 that subscribes to the first telemetry datatype as indicated by the table 260, and the method returns to step 316. In some examples, the collector computing module 210 determines that there is not another subscriber computing module 216 that subscribes to the first telemetry datatype as indicated by the table 260, and the method proceeds back to step 302.

In some examples, the collector computing module 210 determines, for the subscriber computing module 216a, that the time duration has lapsed (at 318), and in response, the method proceeds to step 322. In particular, the collector computing module 210 stops or ceases to provide, to the subscriber computing module 216a, the first telemetry datatype; and further, proceeds to step 322.

In some examples, the scheduler computing module 212 determines that the first sampling frequency is less than (or equal to) the particular sampling frequency (at 310). That is, the scheduler computing module 212 determines that the first sampling frequency of the request from the subscriber computing module 216a is less than (or equal to) the particular sampling frequency that is indicated by the table 260, and provide such data to the collector computing module 210. For example, the first sampling frequency can be every 24 hours (of the request) and the particular sampling frequency (of the table 260) can be every 12 hours. In other words, the particular sampling frequency is the shortest sampling/collection frequency/interval.

In response to determining that the particular sampling frequency is greater than the first sampling frequency, the collector computing module 210 maintains the table 260, at 324. Specifically, the collector computing module 210 maintains the table 260 to keep/maintain the sampling frequency for the first telemetry datatype as the particular sampling frequency. That is, the collector computing module 210 maintains the table 260 to keep the particular sampling frequency for the first telemetry datatype as the particular sampling frequency is a shorter sampling/collection frequency/interval (a “stricter” sampling frequency). For example, the collector computing module 210 maintains the table 260 to keep the sampling frequency for the first telemetry datatype as the particular sampling frequency of every 12 hours. Ultimately, the collector computing module 210 provides, to the subscriber computing module 216a, the telemetry datatype at the particular sampling frequency as indicated by the table 260, at 319. Specifically, the collector computing module 210 can obtain (poll) the first telemetry datatype from the appropriate computing hardware 218 at the particular sampling frequency. That is, at the particular sampling frequency as indicated by the table 260, the collector computing module 210 obtains the first telemetry datatype from the appropriate computing hardware 218. The collector computing module 210 can then provide the first telemetry datatype at the particular sampling frequency to the subscriber computing module 216a (e.g., through the collector computing module 210).

In some examples, the collector computing module 210 determines that the table 260 does not include the first telemetry datatype (at 306); that is, that the table 260 does not include data indicating the first telemetry datatype. In response to determining that the collector computing module 210 determines that the table 260 does not include the first telemetry datatype, the collector computing module 210 updates the table 260 to include the first telemetry datatype and the first sampling frequency for the first telemetry datatype, at 312. That is, the collector computing module 210 updates the table 260 to include the first telemetry datatype and to associate such with the first sampling frequency. Furthermore, the collector computing module 210 further updates the table 260 to add the subscriber computing module 216a as a subscriber of the first the telemetry datatype.

After performing the remediation action (at 320), the collector computing module 210 determines whether there is another subscriber computing module 216 that subscribes to the first telemetry datatype as indicated by the table 260. That is, the collector computing module 210 determines whether the table 260 indicates another subscriber of the first telemetry datatype. In some examples, the collector computing module 210 determines that there is another subscriber computing module 216 that subscribes to the first telemetry datatype as indicated by the table 260, and the method returns to step 316. In some examples, the collector computing module 210 determines that there is not another subscriber computing module 216 that subscribes to the first telemetry datatype as indicated by the table 260, and the method proceeds back to step 302.

In some examples, when the method proceeds back to step 302 (after step 322), the collector computing module 210 receives a second request from the subscriber computing module 216b for the first telemetry datatype of the information handling system 202, at 302. The second request from the subscriber computing module 216b can include a second sampling frequency of the first telemetry datatype. The second request from the subscriber computing module 216b can further include a time duration of subscription to the first telemetry datatype. The time duration can indicate how long the subscriber computing module 216a receives (subscribes to) the first telemetry datatype at the sampling frequency. For example, the time duration can be 1 day, 1 week, or 1 year.

The scheduler computing module 212 can compare the first telemetry datatype to the table 260, at 304. The scheduler computing module 212 determines that the table 260 includes the first telemetry datatype, at 306. In response to determining that the scheduler computing module 212 determines that the table 260 includes the first telemetry datatype, the collector computing module 210 identifies the first sampling frequency for the first telemetry datatype as indicated by the table 260, at 308. That is, the collector computing module 210 identifies the first sampling frequency that is indicated by the table 260 as being associated with the first telemetry datatype.

The scheduler computing module 212 determines whether the second sampling frequency is greater than the first sampling frequency, at 310. In some examples, the scheduler computing module 212 determines that the second sampling frequency is greater than the first sampling frequency (at 310). In response to determining that the second sampling frequency is greater than the first sampling frequency, the collector computing module 210 updates the table 260, at 312. Specifically, the collector computing module 210 updates the table 260 to adjust the sampling frequency for the first telemetry datatype from the first sampling frequency to the second sampling frequency. That is, the collector computing module 210 updates the table 260 to replace the first sampling frequency with the second sampling frequency for the first telemetry datatype as the second sampling frequency (of the second request) is a shorter sampling/collection frequency/interval (a “stricter” sampling frequency). For example, the collector computing module 210 updates the table 260 to adjust the sampling frequency for the first telemetry datatype from the first sampling frequency of every 5 minutes to the second sampling frequency of every 2 minutes.

In some examples, the collector computing module 210 further updates the table 260 to add the subscriber computing module 216b as a subscriber of the first telemetry datatype.

The collector computing module 210, after updating the table 260, identifies the subscriber computing modules 216a, 216b that subscribe to the first telemetry datatype, at 314. The collector computing module 210 identifies, for the subscriber computing module 216a, the time duration, at 316. That is, the collector computing module 210 accesses the table 260 to identify the time duration that is associated with the subscriber computing module 216a for the first telemetry datatype. The collector computing module 210 determines, for the subscriber computing module 216a, whether the time duration has lapsed, at 318. In some examples, the collector computing module 210 determines, for the subscriber computing module 216a, that the time duration has not lapsed (at 318), and in response, provides, to the subscriber computing module 216a, the first telemetry datatype at the second sampling frequency as indicated by the table 260, at 319.

Specifically, the collector computing module 210 can obtain (poll) the first telemetry datatype from the appropriate computing hardware 218 at the second sampling frequency. That is, at the second sampling frequency as indicated by the table 260, the collector computing module 210 obtains the first telemetry datatype from the appropriate computing hardware 218. The collector computing module 210 can then provide the first datatype at the second sampling frequency to the subscriber computing module 216a (e.g., through the collector computing module 210).

The subscriber computing module 216a can perform, based on the second sampling frequency of the first telemetry datatype, a remediation action at the computing hardware 218, at 320. The subscriber computing module 216a can perform a remediation action at the computing hardware 218 in response to receiving the first telemetry datatype. After performing the remediation action (at 320), the collector computing module 210 determines that the subscriber computing module 216b subscribes to the first telemetry datatype as indicated by the table 260, at 322, and the method returns to step 316. The collector computing module 210 identifies, for the subscriber computing module 216b, the time duration, at 316. That is, the collector computing module 210 accesses the table 260 to identify the time duration that is associated with the subscriber computing module 216b for the first telemetry datatype.

The scheduler computing module 212 determines, for the subscriber computing module 216b, that the time duration has not lapsed (at 318), and in response, the collector computing module 210 provides, to the subscriber computing module 216b, the first telemetry datatype at the second sampling frequency as indicated by the table 260, at 319. The subscriber computing module 216b can perform, based on the second sampling frequency of the first telemetry datatype, a remediation action at the computing hardware 218, at 320. The subscriber computing module 216b can perform a remediation action at the computing hardware 218 in response to receiving the first telemetry datatype.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of scheduling telemetry data collection for an information handling system, comprising:
receiving a first request from a first subscriber computing module for a first telemetry datatype of the information handling system, the first request including a first sampling frequency of the first telemetry datatype;
comparing the first telemetry datatype to a table of a plurality of telemetry datatypes stored at a data store, the table indicating, for each telemetry datatype of the plurality of telemetry datatypes, a sampling frequency of the telemetry datatype;
determining, based on the comparing, that the table includes the first telemetry datatype;
identifying, based on the determining, a particular sampling frequency for the first telemetry datatype as indicated by the table;
determining whether the first sampling frequency is greater than the particular sampling frequency;
determining that the first sampling frequency is greater than the particular sampling frequency, and in response:
updating the table to adjust the sampling frequency for the first telemetry datatype from the particular sampling frequency to the first sampling frequency;
after updating the table, identifying one or more subscriber computing modules of the first telemetry datatype; and
providing, to the first subscriber computing module, the first telemetry datatype based on the first sampling frequency.

2. The computer-implemented method of claim 1, wherein updating the table further includes adding the first subscriber computing module as a subscriber of the first telemetry datatype.

3. The computer-implemented method of claim 1, wherein the request includes a time duration, the method further comprising:
determining, for the first subscriber computing module, whether the time duration has lapsed; and
determining, for the first subscriber computing module, that the time duration has not lapsed, and in response, providing, to the first subscriber computing module, the first telemetry datatype based on the first sampling frequency.

4. The computer-implemented method of claim 1, wherein the request includes in a time duration, the method further comprising:
determining, for the first subscriber computing module, whether the time duration has lapsed; and
determining, for the first subscriber computing module, that the time duration has lapsed, and in response, ceasing to provide, to the first subscriber computing module, the first telemetry datatype.

5. The computer-implemented method of claim 1, further including:
determining that the first sampling frequency is less than the particular sampling frequency, and in response:
maintaining the table to keep the sampling frequency for the first telemetry datatype as the particular sampling frequency; and
providing, to the first subscriber computing module, the first telemetry datatype based on the particular sampling frequency.

6. The computer-implemented method of claim 5, wherein maintaining the table further includes adding the first subscriber computing module as a subscriber of the first telemetry datatype.

7. The computer-implemented method of claim 1, further including:
determining, based on the comparing, that the table does not include the first telemetry datatype, and in response:
updating the table to include the first telemetry datatype and the first sampling frequency for the first telemetry datatype.

8. The computer-implemented method of claim 1, further including:
receiving a second request from a second subscriber computing module for the first f telemetry datatype of the information handling system, the second request including a second sampling frequency of the first telemetry datatype;
determining whether the second sampling frequency is greater than the first sampling frequency;
determining that the second sampling frequency is greater than the first sampling frequency, and in response:
updating the table to adjust the sampling frequency for the first telemetry datatype from the first sampling frequency to the second sampling frequency;
after updating the table, providing, to the first subscriber computing module, the first telemetry datatype based on the second sampling frequency; and
providing, to the second subscriber computing module, the first telemetry datatype based on the second sampling frequency.

9. An information handling system comprising a processor having access to memory media storing instructions executable by the processor to perform operations, comprising:
scheduling telemetry data collection for an information handling system, comprising:
receiving a first request from a first subscriber computing module for a first telemetry datatype of the information handling system, the first request including a first sampling frequency of the first telemetry datatype;
comparing the first telemetry datatype to a table of a plurality of telemetry datatypes stored at a data store, the table indicating, for each telemetry datatype of the plurality of telemetry datatypes, a sampling frequency of the telemetry datatype;
determining, based on the comparing, that the table includes the first telemetry datatype;
identifying, based on the determining, a particular sampling frequency for the first telemetry datatype as indicated by the table;
determining whether the first sampling frequency is greater than the particular sampling frequency;
determining that the first sampling frequency is greater than the particular sampling frequency, and in response:
updating the table to adjust the sampling frequency for the first telemetry datatype from the particular sampling frequency to the first sampling frequency;
after updating the table, identifying one or more subscriber computing modules of the first telemetry datatype; and
providing, to the first subscriber computing module, the first telemetry datatype based on the first sampling frequency.

10. The information handling system of claim 9, wherein updating the table further includes adding the first subscriber computing module as a subscriber of the first telemetry datatype.

11. The information handling system of claim 9, wherein the request includes a time duration, the operations further comprising:
determining, for the first subscriber computing module, whether the time duration has lapsed; and
determining, for the first subscriber computing module, that the time duration has not lapsed, and in response, providing, to the first subscriber computing module, the first telemetry datatype based on the first sampling frequency.

12. The information handling system of claim 9, wherein the request includes in a time duration, the operations further comprising:
determining, for the first subscriber computing module, whether the time duration has lapsed; and
determining, for the first subscriber computing module, that the time duration has lapsed, and in response, ceasing to provide, to the first subscriber computing module, the first telemetry datatype.

13. The information handling system of claim 9, the operations further including:
determining that the first sampling frequency is less than the particular sampling frequency, and in response:
maintaining the table to keep the sampling frequency for the first telemetry datatype as the particular sampling frequency; and
providing, to the first subscriber computing module, the first telemetry datatype based on the particular sampling frequency.

14. The information handling system of claim 13, wherein maintaining the table further includes adding the first subscriber computing module as a subscriber of the first telemetry datatype.

15. The information handling system of claim 9, the operations further including:
determining, based on the comparing, that the table does not include the first telemetry datatype, and in response:
updating the table to include the first telemetry datatype and the first sampling frequency for the first telemetry datatype.

16. The information handling system of claim 9, the operations further including:
receiving a second request from a second subscriber computing module for the first telemetry datatype of the information handling system, the second request including a second sampling frequency of the first telemetry datatype;
determining whether the second sampling frequency is greater than the first sampling frequency;
determining that the second sampling frequency is greater than the first sampling frequency, and in response:
updating the table to adjust the sampling frequency for the first telemetry datatype from the first sampling frequency to the second sampling frequency;
after updating the table, providing, to the first subscriber computing module, the first telemetry datatype based on the second sampling frequency; and
providing, to the second subscriber computing module, the first telemetry datatype based on the second sampling frequency.

17. A non-transitory computer-readable medium storing software comprising instructions executable by one or more computers which, upon such execution, cause the one or more computers to perform operations comprising:
scheduling telemetry data collection for an information handling system, comprising:
receiving a first request from a first subscriber computing module for a first telemetry datatype of the information handling system, the first request including a first sampling frequency of the first telemetry datatype;
comparing the first telemetry datatype to a table of a plurality of telemetry datatypes stored at a data store, the table indicating, for each telemetry datatype of the plurality of telemetry datatypes, a sampling frequency of the telemetry datatype;
determining, based on the comparing, that the table includes the first telemetry datatype;
identifying, based on the determining, a particular sampling frequency for the first telemetry datatype as indicated by the table;
determining whether the first sampling frequency is greater than the particular sampling frequency;
determining that the first sampling frequency is greater than the particular sampling frequency, and in response:
updating the table to adjust the sampling frequency for the first telemetry datatype from the particular sampling frequency to the first sampling frequency;
after updating the table, identifying one or more subscriber computing modules of the first telemetry datatype; and
providing, to the first subscriber computing module, the first telemetry datatype based on the first sampling frequency.

18. The non-transitory computer-readable medium of claim 17, wherein updating the table further includes adding the first subscriber computing module as a subscriber of the first telemetry datatype.

19. The non-transitory computer-readable medium of claim 17, wherein the request includes a time duration, the operations further comprising:
determining, for the first subscriber computing module, whether the time duration has lapsed; and
determining, for the first subscriber computing module, that the time duration has not lapsed, and in response, providing, to the first subscriber computing module, the first telemetry datatype based on the first sampling frequency.

20. The non-transitory computer-readable medium of claim 17, wherein the request includes in a time duration, the operations further comprising:
determining, for the first subscriber computing module, whether the time duration has lapsed; and
determining, for the first subscriber computing module, that the time duration has lapsed, and in response, ceasing to provide, to the first subscriber computing module, the first telemetry datatype.
